(19) United States
(12) Patent Application Publication
(10) Pub. No.: US 2012/0011846 A1
(43) Pub. Date: Jan. 19, 2012

(54) Method for Monitoring Pollutant Emissions of a Combustion Engine, Power Train, and Vehicle Fitted With Said Power Train

(75) Inventors: Arnaud Audouin, Paris (FR); Christophe Charial, Rueil-Malmaison (FR); Pierre-Henri Maesse, Rueil-Malmaison (FR)

(73) Assignee: PEUGEOT CITROEN AUTOMOBILES SA, Velizy Villacoublay (FR)

(21) Appl. No.: 13/258,215

(22) PCT Filed: Feb. 12, 2010
(86) PCT No.: PCT/FR10/50241

§ 371 Date: Sep. 21, 2011

(30) Foreign Application Priority Data
Mar. 24, 2009 (FR) 0951853

(51) Int. Cl. F02B 33/44; F01N 3/035; F01N 3/18

(52) U.S. Cl. 60/605.1; 60/274; 60/297

(57) ABSTRACT

The invention relates to a method for monitoring the pollutant emissions of a combustion engine comprising at least one piston (1), the translatable movement of which defines a combustion chamber, said engine being combined with an exhaust line (9) that comprises, in the direction of the exhaust gas flow, an oxidation catalyst (14), an NOx reduction catalyst (15), and a particle filter (18), the method being characterized by the use of a fuel comprising an additive assisting in soot combustion when re-refined by the particle filter (18) and, according to at least one operating mode of the engine, the fuel is injected in accordance with a calibration minimizing carbon dioxide discharges by the engine.

The present invention claims the priority of French application 0951853 filed on Mar. 24, 2009 the content of which (text, drawings and claims) is incorporated here by reference.

The present invention relates to a method for controlling pollutant emissions of a combustion engine.

The use of fossil fuels such as oil or coal in a combustion system, in particular the fuel in an engine, entails the production in non-negligible quantity of pollutants that can be discharged through the exhaust in the environment and can cause environmental damage. Among these pollutants, nitrogen oxides (called NOx) pose a specific problem because these gases are suspected of being one of the factors contributing to the development of acid rain and deforestation. Furthermore, NOx gases are linked to human health problems and are one of the key elements in the development of “smog” (pollution clouds) in the cities. The legislation is imposing increasingly rigorous levels for their reduction and/or their elimination from fixed or mobile sources.

Among the pollutants that the legislation tends to regulate more and more strictly are also soot and other particle materials resulting essentially from incomplete combustion of fuel, more particularly when the engine operates in so-called lean mixture, in other words with excess oxygen (air) relative to the stoichiometry of the combustion reaction. Lean mixtures are used in general for diesel engines, which are ignited by compression.

Different depollution means and combustion strategies are employed for these two main categories of pollutants.

To limit the emission of particles, the technology of particle filters is becoming little by little common for all vehicles equipped with diesel engines. This technology consists in essence in forcing the exhaust gas to pass through the porous channels of a ceramic honeycomb structure. The soot filtered in this manner accumulates and is then eliminated in a regeneration operation of the filter during which the soot is burned. To perform this regeneration, it is however necessary to increase the temperature of the exhaust gas, which is typically obtained by enriching the exhaust gas with fuel (injected directly in the exhaust line or in the combustion chamber of the engine, during the exhaust phase of the combustion cycle) and/or by increasing the charge of the engine. A catalytic agent is used to facilitate the combustion of soot. This agent is either deposited in permanent manner in the filter channels, or introduced as an additive with the fuel. This technology allows for operating at lower combustion temperatures than those required with catalytic filters.

To limit NOx emissions, the main solution employed in current vehicles consists in reducing the emissions at the source, in other words, operating the engine in such conditions that the rate of produced NOx is lower than the limit rate. These conditions are met in particular by monitoring in very accurate manner the different parameters of the engine, starting from the parameters for fuel injection and re-injection at admission of a portion of the exhaust gas, in order to reduce the oxygen concentration favorable to the development of nitrogen oxides.

Since the tolerated emission levels have a tendency of becoming more severe, another solution consists in using a post-treatment arrangement which introduces a reduction agent in the exhaust line. A post treatment solution which has proven its effectiveness is the use of an ammonia source (NH₃), such as aqueous ureum. The ammonia reacts with the NOx on a catalyst to form inert nitrogen N₂ and water H₂O. This solution is essentially known under its English language acronym SCR “Selective Catalytic Reduction”.

In order to treat both the NOx and the particles, the exhaust line must be equipped with two post-treatment devices, a SCR(S) catalyst and a particle filter (F). The latter requires an oxidation catalyst (C) placed upstream of the filter. Therefore, from upstream to downstream in the direction of the exhaust gas flow, we can have four architecture types: SCF, CSF, CFS and CSF.

In patent application WO 2007/132102 the advantages are demonstrated of a CSF type architecture, associated with a modulating supervisor during the regeneration phases of the particle filter, with ureum and fuel injections to compensate the thermal loss of the exhaust gas in the catalyst, in this way avoiding that the gas arrives cooled in the particle filter.

In this text, it is simply indicated that the particle filter can be a known type. As indicated previously, there are basically two main types of particle filters, the so-called non-additive filters (which is improper wording to specify that the fuel does not contain additives, the walls of these filters are provided with a catalytic coating) and additive filters.

The authors of the present invention have discovered that the use of an additive filter was especially advantageous when combined with a judiciously chosen fuel injection strategy.

More precisely, the goal of the invention is a method for controlling the emission of pollutants of a combustion engine comprising at least one combustion chamber for a mixture of air and fuel, said engine is associated with an exhaust line comprising, in the flow direction of the exhaust gas, a NOx reduction catalyst and a particle filter, characterized by the use of a fuel comprising an additive facilitating the combustion of soot during the regenerations of the particle filter, and by the operation of the engine according to at least one main operating mode in which fuel is injected according to a calibration minimizing the discharge of carbon dioxide by the engine.

In well-known manner, combustion engines are calibrated based on tests performed on test benches during which the specific emissions of pollutants to be controlled are measured, in order to select the regulations which for a given operating point (corresponding in essence with a given engine speed and a given torque requirement) lead to a better compromise between CO₂ emissions, pollutants emissions and style (which specifically indicates the capacity to respond in the fastest way to the requirements of the driver). The selection of a calibration that minimizes the discharge of carbon dioxide therefore comes down to reinforcing the fuel consumption requirements, and reducing the NOx emission requirements, without other difficulties at the level of the selection of the calibration.

The NOx reduction catalyst is by preference a SCR type catalyst, while means for injecting a reducing agent, such as for instance an aqueous solution of ureum, are provided upstream of this catalyst. In a variant, this catalyst can consist also of a so called lean mixture NOx trap, also known under its Anglo-Saxon acronym LNT (Lean NOx Trap), in other words a device capable of adsorbing NOx contained in the exhaust gas when the engine operates in lean mixture, whereby NOx is reduced and released when the engine is temporarily operated in rich mixture to regenerate the trap. Besides a catalytic reduction agent on the basis of precious metals such as platinum or rhodium, this type of device comprises in addition an adsorbing agent, typically a compound of an alkaline metal for instance BaCO₃.

To the extent that the exhaust line architecture is compatible with the operation of the engine in a mode that privileges the carbon dioxide reduction at the cost of NOx production, it becomes possible to envisage various simplifications of the engine and pilot strategies associated with it.

A preferred variant of the invention is proposing not to cool the recirculated exhaust gas that is reintroduced at admission, which at the level of the powertrain group results in the elimination of the gas cooling means, and the associated saving of the heat exchanger and eventually the bypass of this exchanger and the valve associated with the bypass.

As indicated previously, the use of EGR gas was the main avenue pursued by the automotive industry for reducing the temperature in the combustion chamber and through this, reducing the quantity of nitrogen oxides produced. This temperature reduction is of course more effective the more the gas is cooled before being mixed with fresh gas. Furthermore, cooling requires an exchanger (called EGR exchanger) and means for bypassing this exchanger. These additional devices increase the weight of the vehicle and therefore increase the fuel consumption.

A variant of the invention is proposing to inject fuel in maximum three injection steps in nominal mode, whereby the main injection is preceded by maximum two pilot injections, outside the regeneration operating mode, in other words it is based on not using multiple complex main injections (or split injection). Nominal mode means outside the operating mode dedicated to the regeneration of the particle filter. This results in fuel consumption gain and in addition reduces the cost of the injectors.

Finally, according to the invention, it is also proposed to operate without compensating the air loop and the injection flows based on measurements of the oxygen quantity in the exhaust gas—which eliminates an oxygen probe.

The present invention has also as object a powertrain group comprising a combustion engine ignited by compression and supplied through fuel injection means with a fuel comprising an additive favoring the combustion of soot during the regenerations of the particle filter, comprising means for recycling a portion of the exhaust gas at admission of the engine, and an exhaust line comprising an oxidation catalyst and, in the direction of the exhaust gas flow, a nitrogen oxide reduction catalyst and a particle trap, characterized in that it comprises means for controlling the engine suitable for implementing a strategy minimizing the production of carbon dioxide by the engine.

By preference, the oxidation catalyst is installed upstream of the nitrogen reduction catalyst.

In a variant, the powertrain group comprises in addition a turbine of a turbocompressor installed in the exhaust line, upstream of the gas depollution means, whereby the means for recycling a portion of the exhaust gas at admission comprise a diversion of gas upstream of said turbine.

In a variant, the fuel supply means do not permit more than 4 fuel injections per piston cycle, of which only 3 when the engine operates in nominal mode, in other words outside the regeneration cycles of the particle filter. This variant allows for the use of less costly injectors, not only because of the reduction of the maximum number of possible injections (in modern engines, the injectors are normally designed for 5 to 7 injections per cycle), which is all the more reason why in nominal mode no more than 3 injections are performed, but also because the cost of an injector depends not only on its capacity of performing high pressure injections (and therefore multiplying the injections per cycle) but also on the total number of injections that will take place over the whole life of the injector.

The NOx reduction catalyst of the powertrain is for instance a lean mixture (LNT) NOx trap or a SCR type catalyst associated with injection means for a reducing agent, installed between the oxidation catalyst and the SCR catalyst.

The goal of the invention is also a vehicle equipped with the previously defined powertrain group.

Other details and advantageous characteristics of the invention will become clear from the following detailed description with reference to the attached figures showing:

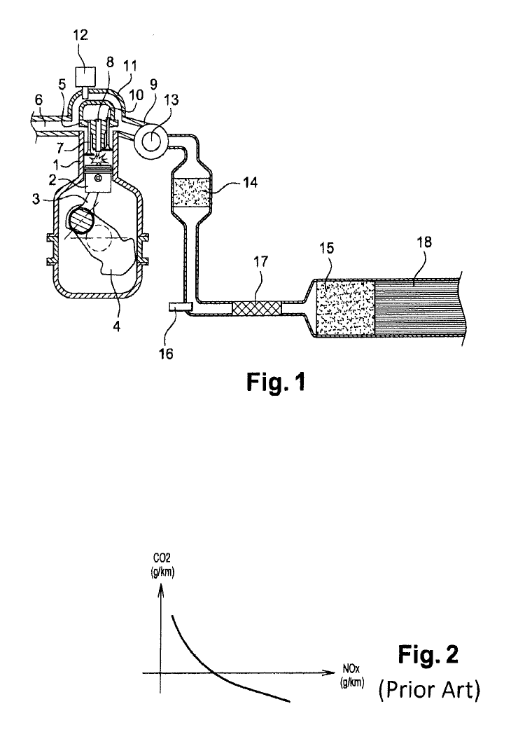

FIG. 1: a schematic view of an engine and its exhaust gas treatment line;

FIG. 2: a diagram showing in non-dimensioned manner the relationship between CO₂ production and NOx production, at the exit of a diesel engine;

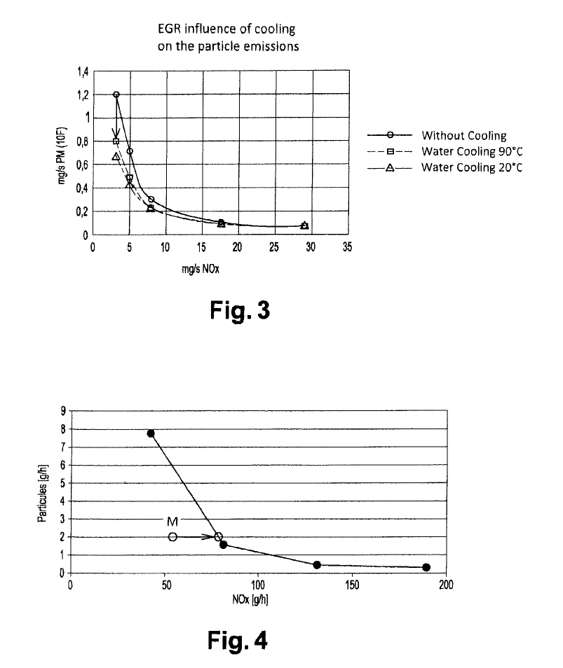

FIG. 3: a comparative graph showing the evolution of particle emissions as a function of the quantity of NOx produced, in which the recirculated gas is cooled to ambient temperature, partially cooled or not cooled.

FIG. 4: a comparative graph showing the evolution of particle emissions as a function of the produced NOx quantity, with or without multiple injection.

To be noted that in the following description, unless otherwise stated, the given ranges include the values at the terminals.

By NOx nitrogen oxide is understood specifically NO monoxide and NO₂ dioxide with, if necessary, a presence of oxides of the type N₂O protoxide, N₂O₃ sesquioxide, N₂O₅ pentoxide.

In the framework of the norms applicable to diesel engines commercialized in Europe, the tolerated pollutant emissions are as follows:

| Norm | CO | Nox | HC + NOx |
|---|---|---|---|
| EURO4 mg/km | 500 | 250 | 300 |
| EURO5 mg/km | 500 | 180 | 230 |
| EURO6 mg/km | 500 | 80 | 170 |

Therefore, according to the Euro6 norm, applicable in 2014, the tolerated levels of oxide emissions will be reduced by a factor 2.25 relative to the Euro5 levels, applicable in 2009.

In practice, the manufacturers have demonstrated that the norm Euro5, for what concerns nitrogen oxides, can be satisfied for small to medium displacement engines by reducing the emissions at the source through optimization of the combustion chamber geometry and integration of various components of the engine, like for instance a low pressure EGR and very accurate calibration of the engine.

For more powerful engines, or to satisfy even more severe norms, specific post treatment devices are provided such as a SCR catalyst (or “Selective Catalytic Reduction”) which reduces NOx by addition of a reducing agent. The normally used reducing agent is ammonia (NH₃), obtained by thermolysis/hydrolysis of ureum in the exhaust line according to the following reactions:

(NH₂)₂CO→HNCO+NH₃:thermalized at 120° C.

HNCO+H₂O→CO₂+NH₃:hydrolyzed at 180° C.

The SCR catalyst serves to promote the reduction of NOx by NH₃ according to the 3 following reactions:

4NH₃+4NO+O₂→4N₂+6H₂O

2NH₃+NO+NO₂→2N₂+3H₂0

8NH₃+6NO₂→7N₂+12H₂O

However, the SCR catalyst is only effective in a temperature range between approximately 180° C. and 500° C., which excludes certain operating conditions of the engines and therefore limits the conversion effectiveness which can be achieved with the SCR principle.

FIG. 1 is a schematic representation of a combustion engine such as a diesel engine according to the invention. The engine comprises at least one piston 1, which travels in translation in a cylinder 2, and the alternative translation movement of the piston is transmitted by connecting rod 3 to crankshaft 4.

Cylinder 2 delimits with piston 1 and cylinder head 5 a combustion chamber in which fresh air is introduced via conduit 6, and admitted into the chamber depending on the position of inlet valve 7. Fuel, for instance, diesel or a bio fuel such as a diester is sprayed in the combustion chamber by injector 8. The mixture is compressed to a sufficiently high pressure for auto-ignition of the air-fuel mixture and the combustion gas is evacuated through an exhaust conduit 9, the opening of which is commanded by an outlet valve 10 and leads into an exhaust collector. From this collector, a conduit 11 serves for the recirculation of a portion of the exhaust gas, a valve called EGR 12 valve controls the exhaust gas flow that is reintroduced at admission.

The here illustrated exhaust line comprises, in the direction of gas circulation, for instance a turbine 13, driven by the exhaust gas and the shaft of this turbine drives for instance a compressor placed in the inlet line of the fresh gas (not shown here). The exhaust gas passes then through an oxidation catalyst 14 which has as primary role to oxidize into carbon dioxide the carbon monoxide contained in the gas exiting the engine.

Downstream of the oxidation catalyst 14, the exhaust gas passes through a NOx treatment catalyst 15. In the case of FIG. 1, this catalyst is a SCR catalyst, containing injection means for a reducing agent such as ureum (injector 16). According to the case, a mechanical decoupler 17 can be installed between injector 16 and SCR catalyst 15. A particle trap 18, by preference placed side by side with catalyst 15, is arranged downstream of this catalyst 11.

As illustrated in FIG. 1, if this SCR catalyst is installed in the exhaust line upstream of the particle filter, the temperatures necessary for its activation can be attained relatively easy so that this catalyst is capable of treating very effectively NOx quantities without any relation to the conventional NOx quantities.

For many years, engine manufacturers have developed fuel injection strategies aimed at minimizing the production of NOx. As illustrated in FIG. 2, in dotted line, these strategies consist in particular in performing an injection in two or three steps, with one or two pilot injections preceding the upper dead point and a main injection past this upper dead point.

If, according to the invention, the priorities are reversed considering that the location of the SCR catalyst upstream of the particle filter makes the catalyst extremely effective, very substantial gains in fuel economy can be achieved. However this gain is obtained at the cost of a very high increase in NOx, in the order of 200 to 250% or more, a deterioration which seems a total failure according to current practices. The graph of FIG. 2 shows in fact that the CO₂ gain entails a NOx degradation and inversely.

The first of these gains is linked to the suppression of the EGR exchanger and is illustrated by means of FIG. 3 which represents the relationship between the NOx produced by the engine and the quantity of particles produced, as a function of the quality of the gas cooling.

To be noted that the fact of cooling the recirculated gas allows for a reduction of particles, at constant nitrogen oxide rate.

As a reminder, the EGR circulates in the exchanger only when the engine is hot, which corresponds approximately with a period where the SCR system is fully active. Therefore, an engine regulation can be used which, per iso emissions of particles, emits significantly more NOx relative to the initial regulation. (example: if point A is the base regulation, the engine emits approximately 7.5 mg/s of NOx for 0.2 mg/s of particles. If now the regulation of the engine is compensated to emit 10.5 mg/s of NOx, the particle rate is no longer dependent on the cooling of the recirculated gas.

It is evident that the suppression of the EGR exchanger eliminates its weight. In addition, in these conditions, it is of course no longer necessary to provide a bypass for this exchanger for certain operating points of the engine, which results in supplementary weight savings. Limited to a simple regulation valve, the EGR module sees its cost divided by two relative to a complete module, associating with valve an exchanger and a bypass.

Moreover, the fact that the hotter gas is reintroduced in the combustion chamber has a tendency of reducing the combustion noise.

The integration under the hood of an exchanger and a bypass is not easy, therefore the fact that they are eliminated frees up space for other systems—in particular stop-start systems and associated means for storing electricity—or for improving the problems of collisions with pedestrians.

Another very important point is that of the simplification of the fuel injection means. Indeed, to limit the emissions of NOx and particles, a good performing injection system is required allowing for a high number of injections per cycle—and therefore with very fast response time. Typically, in high performance systems, there are 4 injections per cycle: 2 pilot injections, and one main injection split in 2 in nominal mode, this number can climb to 5 or 6 in regeneration mode.

These multiple injections only make sense if the injection system is capable of dosing in a correct manner the injected quantities (or at least as correctly as possible), with very short intervals between injections. These imperatives have led to the development of very high performance injectors such as piezoelectric injectors and injectors with specific design of the fuel supply lines in order to limit the effects of pressure surges even if the fuel has very high pressure.

FIG. 4 illustrates the compromise between the particle emission rate and the NOx emission rate, knowing that environmental standards cap both limits. Clearly, any NOx gain is very penalizing for all particle emissions since the NOx emissions are capped at approximately 75 g/h. Point M shows that while proceeding with multiple injections, it is nevertheless possible to reduce the NOx emission rates to approximately 55 g/h per iso particle discharge.

If according to the invention we allow excess NOx emission at the exit of the engine (this excess emission is treated in the exhaust line via the post treatment system), multiple injections are no longer necessary.

Since proceeding with multiple injections means penalizing in terms of fuel consumption (since the injections need to be spaced in time, and are therefore not performed exactly at the time that the energy yield of the engine is optimal), suppressing these multiple injections entails an immediate consumption gain. On the other hand, this suppression allows for the use of simpler injection systems, for instance injectors based on solenoid technology.

This suppression allows also for simplifying the architecture of the common injection rail, in particular the need for providing calibrated holes (or nozzles) in the calibrated rails, which are provided in order to limit pressure surges in common injection rails. By limiting the number of injections per cycle time, the injection pressure can be reduced effectively and therefore also the need for compensating the effects of too high pressure. FIG. 4 explains also another important point of the invention: in the zone of low NOx emissions, around point M, any drift of the system can entail a very high increase of the quantity of emitted particles.

If the quantity of particles is too high, the regeneration of the filter can produce very high temperatures which make the filter fragile, and therefore in the long run, affect the emissions of particles. For this reason, an oxygen probe is normally installed in the exhaust line to minimize this risk of excess particle emissions in order to compensate the air loop and the injection flow which risk of drifting over time, in particular due to the clogging of the EGR circuit and the injection circuit.

If according to the invention very high NOx emission rates are authorized, for instance in the circled zone around 135 g/h, it is observed that the particle rate is low and in essence stable. In these conditions, it is no longer necessary to compensate the injection starting from the information of the oxygen probe.

By modifying the base problem and choosing to install a very high performance NOx treatment system, a large portion of the engine can be reconfigured using less costly elements for the EGR systems, the fuel injection and the exhaust line, so that on the one hand, these less costly elements compensate a large portion of the extra cost associated with the installation of the NOx post treatment system, while minimizing certain vehicle maintenance costs.

These equipment gains are accompanied by a more than very significant reduction in consumption so that the vehicle in its totality pollutes less than a vehicle equipped a priori with a series of more sophisticated devices.

1. A method for controlling the pollutant emissions of a combustion engine comprising a combustion chamber for a mixture of air and fuel, said engine associated with an exhaust line comprising, in the direction of the exhaust gas flow, a NOx reduction catalyst and a particle filter, wherein the method comprises:
providing a fuel comprising an additive for combusting soot during regenerations of the particle filter;
operating the engine according to at least one main mode of operation; and
injecting the fuel into the combustion chamber according to a selected CO₂ calibration to minimize the carbon dioxide discharged by the engine.

2. The method according to claim 1, wherein said operating mode minimizing the carbon dioxide discharge is obtained by re-injecting a portion of the exhaust gas, without cooling it, into an inlet circuit of the engine.

3. The method according to claim 1, wherein said operating mode minimizing the carbon dioxide discharge is obtained by injecting the fuel in the combustion chamber the engine in a maximum of three injection steps per cycle in a nominal mode.

4. The method according to claim 1, wherein said operating mode minimizing the carbon dioxide discharge is obtained by injecting the fuel according the selected CO₂ calibration, wherein the selected CO₂ calibration does not use a quantity of oxygen in the exhaust gas as an input parameter.

5. A powertrain comprising:
a combustion engine structured and operable to compress a fuel, supplied by an injection means, the fuel comprising an additive for promoting the combustion of soot during a regeneration of a particle filter of the powertrain;
a means for recycling a portion of exhaust gas produced by the engine at an inlet of the engine;
an exhaust line comprising an oxidation catalyst and, in the direction of the exhaust gas flow, a nitrogen reduction catalyst and a particle trap; and
a means for controlling the engine to implement a strategy that reduces the production of carbon dioxide by the engine.

6. The powertrain according to claim 5, wherein the oxidation catalyst is installed upstream of the nitrogen oxide reduction catalyst.

7. The powertrain according to claim 5 or claim 6, wherein a turbine of a turbo compressor is installed in the exhaust line upstream of a gas depollution means and wherein the means for recycling a portion of the exhaust gas at the inlet comprises a diversion of gas upstream of said turbine.

8. The powertrain according to claim 5, wherein a fuel supply means of the powertrain is structured and operable to allow a maximum of four injections per cycle during regeneration phases of the particle filter, and maximum of three injections per piston cycle in a nominal mode.

9. The powertrain according to claim 5, wherein the NOx reduction catalyst is one of a lean mixture NOx trap (LNT) and a SCR type catalyst associated with the injection means installed between the oxidation catalyst and the SCR catalyst.

10. A vehicle comprising a powertrain, wherein said powertrain comprises:
a combustion engine structured and operable to compress a fuel, supplied by an injection means, the fuel comprising an additive for promoting the combustion of soot during a regeneration of a particle filter of the powertrain;
a means for recycling a portion of exhaust gas produced by the engine at an inlet of the engine;
an exhaust line comprising an oxidation catalyst and, in the direction of the exhaust gas flow, a nitrogen reduction catalyst and a particle trap; and
a means for controlling the engine to implement a strategy that reduces the production of carbon dioxide by the engine.
